(19) United States
(12) Patent Application Publication
(10) Pub. No.: US 2026/0278000 A1
(43) Pub. Date: Sep. 17, 2026

(54) BUFFER MANAGEMENT

(71) Applicant: NVIDIA Corporation, Santa Clara, CA (US)

(72) Inventors: Piotr Andrzej ZELASKO, Wellington, FL (US); Daniel Thomas Galvez, Palo Alto, CA (US); Vitaly Sergeyevich Lavrukhin, Campbell, CA (US); Boris Ginsburg, Sunnyvale, CA (US)

(21) Appl. No.: 19/076,691

(22) Filed: Mar. 11, 2025

(51) Int. Cl. G06F 16/901; G06N 20/00

(52) U.S. Cl. CPC G06F 16/901; G06N 20/00

(57) ABSTRACT

In various examples, systems and methods are disclosed for a two-dimensional (2D) dynamic bucket pre-processor that enhances the efficiency of machine learning model training on GPUs. The 2D dynamic bucket pre-processor includes a bucket stratification optimizer that configures a 2D bucket buffer for performing stratified 2D bucketing by organizing data into first-tier and second-tier sub-buckets, and a batch size optimizer to identify optimal batch sizes that fit into GPU memory. During training of a machine learning model, micro-batches comprise data served from selected sub-buckets to a model training platform. Organizing data into first and second tiers based on sequence length dimensions minimizes padding and ensures efficient GPU processing. In some embodiments, the 2D dynamic bucket pre-processor may perform 2D bucketing as a dynamic process that streams data into the 2D bucket buffer, as micro-batches of previously bucketed data are being served to execute training steps of a model training process.

### BACKGROUND

Training machine learning models, such as neural networks, involves transforming input data through a series of nested functions applied to input parameters, often referred to as deep learning. The primary objective when training a model using deep learning is to optimize these parameters, which include weights and biases that may be stored in tensors, by computing their partial derivatives (e.g., gradients) with respect to a loss metric. During forward propagation, the neural network processes the input parameters and generates a confidence score that is passed through successive layers to the output layer. In backpropagation (e.g., gradient descent), an error score is propagated back through the neural network in a process adjusting the weights to improve the model. Tensors are a type of multidimensional data structure that may be used to store and manipulate the inputs, outputs, and parameters of a machine learning model, and which may be optimized to run quite efficiently on graphics processing units (GPUs). The parallel nature of neural networks may be leveraged to efficiently develop kernels for execution on GPUS, representing a substantial speed-up over central processing unit (CPU)-based training. Modern deep learning frameworks often represent neural networks as graph structures of computations, maintaining a directed acyclic graph (DAG) of tensors and executed operations. A DAG is a directed graph that contains no cycles, but has vertices and edges, where each edge points from one vertex to another. Tensors may be used for machine learning model training processes that involve fixed dimension training samples (e.g., fixed resolution image data) or variable length sequence data (e.g., natural language or speech data).

### SUMMARY

Embodiments of the present disclosure relate to buffer management for sampling sequence-based data for processors—such as graphics processing units (GPUs) and/or other parallel processor types. Systems and methods are disclosed that provide technologies for optimally processing variable length data using tensors run on, e.g., GPUs.

In contrast to conventional systems, the embodiments presented herein introduce a two-dimensional (2D) dynamic bucket pre-processor that significantly enhances the efficiency of machine learning model training on GPUs. The 2D dynamic bucket pre-processor performs batch size-optimized 2D dynamic bucketing to prepare mini-batches of data thread samples for GPU processing on a model training platform. Unlike traditional padding or bucketing methods, this pre-processor performs batch size-optimized 2D dynamic bucketing, which reduces wasted computation resources and under-utilization of GPU memory and cores. The 2D dynamic bucket pre-processor may include a batch size optimizer that computes optimal GPU utilization for variable sequence lengths. More specifically, in some embodiments, the batch size optimizer may optimize a lower bound of GPU utilization by selecting the largest possible batch sizes that fit into the GPU memory. The batch size optimizer may compute the optimization based on running the machine learning model on the GPU in a loop, and performing a search algorithm to identify a lower bound of GPU utilization automatically, based on an initial (e.g., seed) batch size setting. The batch size optimizer may use a search algorithm, such as a binary search variant, to identify the optimal batch sizes that fit into GPU memory. By running full training steps with pseudo data, the optimizer accurately estimates GPU memory utilization and iteratively adjusts batch sizes to find the optimal setting.

In some embodiments, the two-dimensional (2D) dynamic bucket pre-processor includes a bucket stratification optimizer that configures a 2D bucket buffer for performing stratified 2D bucketing by organizing data into first-tier and second-tier buckets, and based on these dimensions, minimizes padding and ensures efficient GPU processing. The bucket stratification optimizer may estimate optimal 2D bucket sizes by computing sequence length histograms on the training data. The two-dimensional (2D) dynamic bucket pre-processor may sort input data sequences and allocate them to buckets sequentially until a maximum bucket sequence length sum is exhausted. Each bucket may be subdivided into sub-buckets, such that each holds a similar total amount of data.

During training of a machine learning model, micro-batches comprise data from selected sub-buckets. The sub-buckets may be selected from the 2D bucket buffer for processing based on an interleaved selection scheme so that the progression through training steps avoids intervals of training with a constant sequence length. As such, each bucket of the 2D bucket buffer may be processed in about the same amount of time (e.g., rather than having buckets of smaller-sized tensors exhausted quickly while others are exhausted late in the training). Stratified 2D bucketing sampling may be performed dynamically (e.g., as opposed to being fully completed as a special pre-processing step) before feeding micro-batches to a model training process.

In some embodiments, the two-dimensional (2D) dynamic bucket pre-processor may perform 2D bucketing as a dynamic process that streams data into the buckets, as micro-batches of previously bucketed data are being served to execute training steps of the model training process. That is, the bucket stratification optimizer may add data to buckets as the model training process draws data from the buckets. In this way, the actual size of the buffer implementing the buckets may be bounded to a modest-sized buffer (e.g., without taxing the limits of the computing system hosting the buffer).

### BRIEF DESCRIPTION OF THE DRAWINGS

The present systems and methods for buffer management for sampling sequence-based data for processors are described in detail below with reference to the attached drawing figures, wherein:

FIG. 1 is an example data flow diagram for a process for batch size-optimized 2D dynamic bucketing for a machine learning model training system, in accordance with some embodiments of the present disclosure;

FIG. 2 is an example data flow diagram for a batch size optimizer of a 2D dynamic bucket pre-processor, in accordance with some embodiments of the present disclosure;

FIG. 3 is a diagram illustrating an example of 2D bucket buffers comprising the first tier of stratified buckets and a second tier of stratified buckets (sub-buckets), in accordance with some embodiments of the present disclosure;

FIG. 4 is a flow chart illustrating an example method for batch size-optimized 2D dynamic bucketing, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to buffer management for sampling sequence-based data for processors—such as graphics processing units (GPUs) and/or other parallel processor types. More specifically, the systems and methods presented in this disclosure provide for technologies for optimally processing variable length data using tensors run on GPUs. Although GPUs are primarily described herein, this is not intended to be limiting, and other parallel processor types—e.g., parallel processing units (PPUs), vector processing units (VPUs), pixel processing engines (PPEs), etc.—may be implemented without departing from the scope of the present disclosure.

While GPUs are particularly well-suited for executing neural networks, an efficiency challenge nonetheless emerges with respect to variable length data, which cannot be neatly packed as is into a statically sized tensor. Unlike image data, audio data can be variable in length so that using standard size buffers creates inefficiencies. For example, given a dataset of input image data representing 1024-by-1024-pixel-sized frames for batch processing on a GPU, the dimension of a corresponding three-dimensional tensor with respect to batch size, height, and width is static and therefore predictable across the dataset and accordingly straightforward to optimize buffers for the data flow. In contrast, sequence-based data often comprises variable length data samples that are not so straightforward to optimize. For example, a dataset of speech data may comprise recorded data sampled at a given rate, but individual samples of input data may comprise recordings of arbitrary length, such as 5, 7, or 30 seconds of duration, for example. Similar variability can occur with language data comprising sequences of words, characters, or tokens, or video data where data samples may comprise an arbitrary number of frames depending on the length of a video segment. In each of these scenarios, designing a common tensor structure that may be replicated across GPU threads to process multiple data samples in parallel (e.g., at one time) is complicated by the lack of uniformity in data length of the data being processed in parallel and the inability to establish a standard size buffer that can accommodate the tensors efficiently. While ragged tensors, which comprise tensors in which elements in one or more dimensions have a variable size, are a known data structure, utilizing ragged tensors requires the development of specialized GPU kernels that are generally not available in popular deep machine learning frameworks such as PyTorch.

One established technique for processing variable length data involves buffer padding. With buffer padding, extra padding data (e.g., pseudo tokens, frames, or other data) are appended to buffered parallel data threads to bring each thread to the same fixed length. That is, each buffered data sample that is shorter than the pre-established fixed length is augmented with padding data at the end—where that padding data is processed by the GPU but does not contribute to a computed solution. A statically sized tensor may therefore be uniformly processed across the GPU cores for each data thread. However, processing of padding data is a particularly wasteful inefficiency with respect to GPU resources, because such processing represents time and energy used in performing computations that do not bring value.

Another approach often used for processing variable length data is known as bucketing. Bucketing techniques stratify the sampling by sequence length. As a result, a mini-batch of sequenced data may be passed from a bucket to a GPU such that each mini-batch has data samples with very similar dimensions that require little to no padding data. That is, because each bucket represents data of similar sequence length, the amount of padding data needed to bring each sample to the same fixed length is well-bounded and can be managed by adjusting the stratification criteria. There is less variability in terms of sequencing when creating mini-batches to run GPU training algorithms, and wherein batch size can be more efficiently managed. For example, for processing a bucket holding very short data samples, larger batches may be processed, and for processing a bucket holding very long data samples, smaller batches may be processed—so the total amount of processed input data (e.g., speech duration, text tokens, video frames, etc.) is roughly similar between the batches.

However, implementing bucketing techniques to establish an effective bucket stratification strategy for a given set of sequence-based data involves overcoming several challenges. A first challenge involves how to efficiently and quickly determine maximal batch sizes for each bucket that will fit on a given GPU device without incurring memory errors. A second challenge with bucketing is that stratification on the sequence length is not sufficient for a maximal device utilization for certain types of models—specifically, sequence-to-sequence models such as an attention-encoder-decoder model that in fact has two sequence length dimensions that are susceptible to padding (e.g., an input sequence length and an output sequence length). A third challenge with bucketing is applying the technique to datasets of sequenced data that may be enormously large (e.g., terabytes to petabytes of data, or larger), such as datasets comprising hundreds of thousands or hours of recorded language data, for example. More specifically, partitioning datasets of such large sizes into buckets itself represents a task that consumes enormous processing resources in terms of compute time, memory, and energy.

In contrast to these existing technologies, the embodiments presented herein provide for a two-dimensional (2D) dynamic bucket pre-processor. The 2D dynamic bucket pre-processor performs batch size-optimized 2D dynamic bucketing to prepare mini-batches of data thread samples for GPU processing. Unlike padding or traditional bucketing, the batch size-optimized two-dimensional dynamic bucketing described herein may be used to reduce factors that contribute to inefficient machine learning model training, such as wasted computation resources applied to padding data, and under-utilization of GPU memory and cores due to excessively small datasets given the potential amount of parallelism that may be performed on the GPU. In practice, the combination of 2D bucketing and batch size optimization described herein has been observed to increase the average batch size by five times (over prior approaches) for NVIDIA NeMo Canary-1B model training, and by three times (over prior approaches) for a multimodal variant of NVIDIA NeMo SALM SpeechLLM. Moreover, Canary-1B can be effectively trained using the 2D bucketing and batch size optimization described herein for the same amount of time as baseline methods using four times fewer the number of GPUs, or in half of the time using the same number of GPUs. As such, the embodiments herein provide for optimizers and other functions that address the challenges of effective bucketing to prepare mini-batches of data thread samples for GPU processing.

With respect to the first challenge of determining optimal batch size, attempting to manually tune fixed batch sizes for each bucket, or to use formulas to select bucket size thresholds (e.g., a threshold for the sum of sequence lengths not to be exceeded) are non-trivial tasks because deep learning models comprise many different operations corresponding to different memory complexities (e.g., linear complexity verses quadratic complexity with regards to the sequence length). In other words, for a complex machine learning model of many layers and many different types of operators, it becomes exceedingly difficult to predict exactly how much memory the GPU will need up front. The traditional approaches typically result in under-utilizing the GPU memory and cores, or require debugging of out-of-memory issues, such as those caused by sequence length outliers, for example.

In some embodiments, a two-dimensional (2D) dynamic bucket pre-processor may comprise a batch size optimizer that computes an optimal GPU utilization for variable sequence lengths. More specifically, in some embodiments, the batch size optimizer may optimize a lower bound of GPU utilization by selecting the largest possible batch sizes that fit into the GPU memory. The batch size optimizer may compute the optimization based on running the machine learning model on the GPU in a loop, and performing a search algorithm to identify a lower bound of GPU utilization automatically, based on an initial (e.g., seed) batch size setting. The search algorithm may be implemented using, for example, a binary search variant. In some embodiments, the batch size optimizer may start with a batch size setting and run a full training step of the model, for example using a set of pseudo (e.g., random) input data. Pseudo data is adequate for the purpose of batch size optimization because the actual content of the data processed has no effect on GPU processing efficiency and is only relevant to optimization with respect to its sequence length. In some embodiments, the batch size optimizer performs a full training step of the model (e.g., including forward propagation, backward propagation, and parameter updates) in order to obtain an accurate estimate of the actual GPU memory utilization that would be incurred during a real training step. Starting with an initial seed (e.g., a guess) for a batch size, if those tasks can be completed without the GPU running out of memory, then the pass with that batch size is marked as a successful training step. A next optimization iteration may then be performed using an increased batch size (e.g., two times the previous successful batch size). If instead an out-of-memory error is raised during an optimization iteration, the batch size is marked as invalid, and the batch size is decreased (e.g., reduced by half) for the next iteration. Once the batch size optimizer has determined at least one successful and one invalid batch size, the middle point settings may be recursively tested to a convergence point (e.g., within a convergence threshold), which may be defined as the optimal batch size for the memory configuration of that GPU. In order to bound the number of optimization iteration steps needed to converge on an optimal batch size, the batch size optimizer may apply a convergence threshold, which is computed from the delta between valid and invalid batch size normalized by the larger number. For example, a 5% convergence threshold would mean that once a valid batch size (e.g., of 95) and an invalid batch size (e.g., of 100) is found, the batch size optimizer may stop the search process and define the batch size of 95 as being the optimal batch size setting. With this technique, a batch size optimizer may be expected to converge on an optimal batch size within about ten iteration steps per each bucket being optimized.

With respect to the second challenge of determining a bucketing stratification strategy, the model training system may further comprise a bucket stratification optimizer that works in conjunction with the batch size optimizer to perform stratified two-dimensional (2D) bucketing sampling. As discussed above, a tensor used for model training may comprise two sequence length dimensions that are susceptible to padding (e.g., an input sequence length dimension and an output sequence length dimension). As an example, for tensors representing audio data for use with training a speech-to-text model, the duration and content of an input utterance and the number of tokens in the text prediction may represent two independent sequence length dimensions. A first input sample of audio data of five seconds of speech containing eight words may correspond to eight tokens for the model to predict (e.g., where individual tokens may correspond to a subword/segment of a word, and/or in some instances, a complete word). A second input sample from someone else who speaks at a faster rate may also be five seconds in duration, but correspond to sixteen tokens for the model to predict. Stratification just on the input sequence length may sort both the first and second input samples into the same bucket (e.g., a 5- to 10-second bucket), but the differences in the output sequence length would call for substantial differences in padding to obtain a same-sized tensor for processing. The same may be true for machine translation (e.g., document translation) where the number of tokens in the source language sentence represents a sequence length dimension that is independent of a sequence length dimension of the predicted target language sentence. Stratification on just one of the two sequence length dimensions still results in wasted computation due to padding. As an example, because an attention decoder typically requires more computations due to source-target attention operation and its autoregressive architecture, training of attention-encoder-decoder models with stratification on the input sequence length typically results in underutilizing the full capabilities of GPU devices.

As such, in embodiments, the bucket stratification optimizer described herein accounts for variability in the input and predicted output sequence length dimensions. That is, the bucket stratification optimizer provides for two-dimensional bucketing. In some embodiments, a first tier of stratified buckets corresponds to the sequence length dimension of the input. Then, each first-tier bucket includes within it a second tier of stratified buckets (or sub-buckets) that corresponds to the sequence length dimension of the output prediction. For example, in the above example of first and second input samples of audio data, both samples may be sorted into the same first-tier bucket (e.g., a 5- to 10-second bucket), as they both have a same input sequence length of five seconds, but within that first-tier bucket, the samples would be sorted into different second-tier buckets based on their predicted output sequence lengths. As such, a given sample of the audio data may occupy a sub-bucket comprising other samples that are closely similar with respect to both their first and second dimensions, and therefore the data samples from that sub-bucket may be represented and processed by a GPU using a tensor with first and second dimensions configured for that sub-bucket, and thus needing little to no padding data. Training of the machine learning model may proceed based on selecting and using tensors derived from a selected sub-bucket (e.g., a micro-batch) for a given training step with GPU processing cycles and memory being efficiently utilized. Moreover, the number of tensors extracted from a sub-bucket to perform that training step may be determined by the batch size optimizer, as described above. For performing the next and subsequent training steps, different first-tier/second-tier buckets may be selected (e.g., randomly), and a micro-batch of tensors (the number of which may be determined by the batch size optimizer) processed from the corresponding sub-bucket.

In some embodiments, the stratifications of first-tier and second-tier buckets are structured by the bucket stratification optimizer such that each first-tier bucket will be allocated a specified, not necessarily equal, quantity of sequenced data. The bucket stratification optimizer may estimate optimal 2D buckets by computing one or more sequence length histograms on a sample (or entirety) of the training data. In other words, bucket bin boundaries may be determined such that each bucket (and/or sub-bucket within a given bucket) has approximately an equal sum of the lengths of its sequences. To that end, the bucket stratification optimizer may sort the input data sequences, divide their sequence length sum by the desired number of buckets (e.g., a selected hyperparameter), and iterate over the sorted examples, allocating them to buckets sequentially until a maximum bucket sequence length sum is exhausted. Then, for each individual bucket, the bucket stratification optimizer performs the same procedure sub-dividing the bucket into a fixed number of sub-buckets (e.g., another selected hyperparameter) and iterates over the sorted examples of the bucket, allocating them to sub-buckets sequentially until a maximum sub-bucket sequence length sum is exhausted. In some implementations, the goal may be to establish bucket and sub-bucket boundaries in such a way that they hold roughly the same total amount (e.g., seconds, hours, tokens, etc.) in duration of data. As such, though a set of sub-buckets may hold a similar total amount of data, a sub-bucket corresponding to smaller-sized 2D tensors may hold many more individual data samples than a sub-bucket corresponding to larger-sized 2D tensors.

During training of a machine learning model, micro-batches comprise data from selected sub-buckets. The sub-buckets may be selected for processing based on an interleaved selection scheme (e.g., randomly) rather than sequentially so that during training, the progression through training steps avoids intervals of training with a constant sequence length. This optimization ensures that during training, each bucket (and/or sub-bucket) may be processed in about the same amount of time rather than having buckets of smaller-sized tensors exhausted quickly while others are exhausted very late in the training (which could break some assumptions about random sampling and have a detrimental effect in the training).

In some embodiments, to address the third challenge, the stratified 2D bucketing sampling may be performed dynamically (e.g., as opposed to being fully completed as a special pre-processing step) before feeding micro-batches to the model training process. Moreover, the buckets may be instantiated using off-GPU resources such as a central processing unit (CPU) memory buffer (e.g., to hold 20k-50k samples) that feeds a micro-batch from the selected sub-bucket to the model training process. The buffer may be sub-divided into smaller variable length buffers to define each bucket/sub-bucket combination. As input sequenced data is received, each sample may be allocated into a specific bucket's assigned buffer, and shuffled by inserting the sample at a random position within the buffer to improve the randomness of sampling when serving out a micro-batch. In order to allocate an input data sample to a bucket on the fly, the bucket stratification optimizer may first measure the sample's 2D length to yield a vector of L1 (the first sequence length dimension) and L2 (the second sequence length dimension), and apply a binary search to match L1 to the corresponding first tier of buckets (e.g., based on input sequence length), and apply a binary search to match L2 with the second tier of buckets (e.g., sub-bucket) based on the second dimension (e.g., output sequence length). In order to reduce the lag between the start of filling the bucket and the start of the model training process, a separate CPU thread may be executed to perform the buffer feeding task, and to start serving mini-batches once the buffer is at least a threshold percent populated (e.g., 10%), where the specific threshold may be tuned higher for very large batch sizes relative to the buffer's size.

As mentioned, large datasets may include terabytes to petabytes (or more) of data (e.g., representing hundreds of thousands of hours of sequential data, such as recordings). Since partitioning a dataset of such sizes into buckets can take a very substantial amount of time to complete (and consume a proportionally large amount of data storage), a two-dimensional (2D) dynamic bucket pre-processor may perform 2D bucketing as a dynamic process that streams data into the buckets, as micro-batches of previously bucketed data are being served to execute training steps of the model training process. That is, the bucket stratification optimizer may add data to buckets as the model training process draws data from the buckets. In this way, the actual size of the buffer implementing the buckets may be bounded to a modest-sized buffer (e.g., without taxing the limits of the computing system hosting the buffer).

In some embodiments, the batch size optimizer and/or bucket stratification optimizer may be implemented as a pre-processor stage that manages the data that is served into the model training platform as micro-batches. In some embodiments, the pre-processor may be executed as one or more threads on the same one or more GPUs performing model training, or at least in part executed as one or more threads executed as sub-process(es) (e.g., operating in the background) on a CPU that handles loading and pre-processing of the initial sequenced data inputs. Such a pre-processor gatekeeper to implement the 2D bucketing described herein may be executed at least in part on a computing device and/or cloud-based computing platform. In some embodiments, 2D bucketing as a pre-processing operation may be implemented as a network service (e.g., a data loading service) hosted by a cloud-based computing platform, where a user subscribed to the service may incorporate the 2D bucketing pre-processing operation to a model training pipeline.

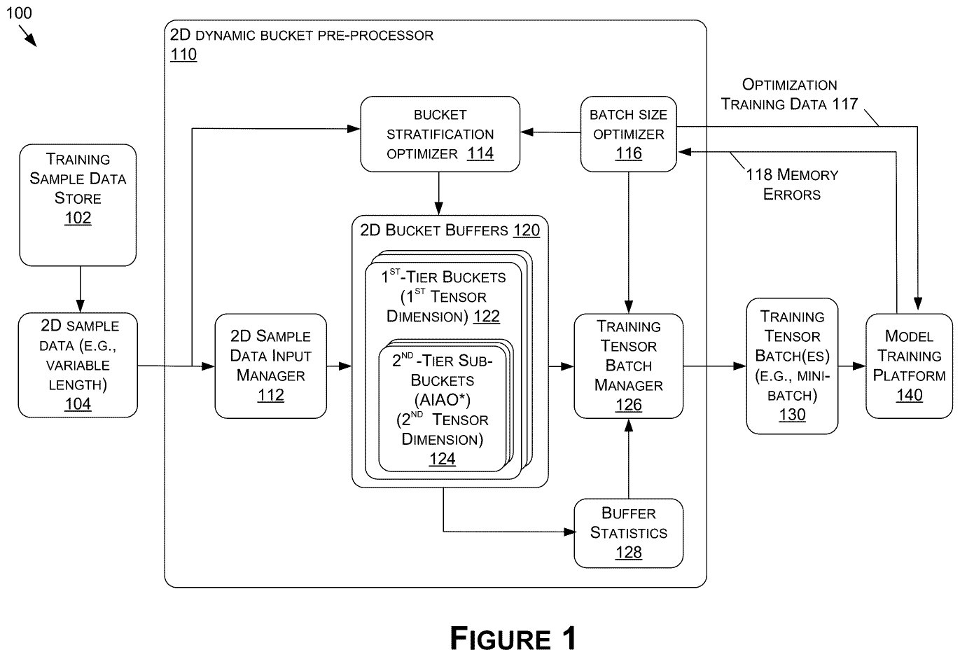

With reference to FIG. 1, FIG. 1 is an example data flow diagram for a process for batch size-optimized 2D dynamic bucketing for a machine learning model training system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors (e.g., comprising processing circuitry) executing instructions stored in memory.

As shown in FIG. 1, the machine learning model training system 100 may comprise a 2D dynamic bucket pre-processor 110 that receives sequence-based 2D variable length sample data 104 (which may be obtained, for example, from a training sample data store 102 or other source), and generates one or more training tensor batches (e.g., mini-batches) 130 which may be served to a model training platform 140 and used for training a machine learning model. The batch size-optimized two-dimensional dynamic bucketing described herein produces training tensor batches 130 that are optimized to reduce factors that contribute to inefficient machine learning model training, such as wasted computation resources applied to padding data, and under-utilization of GPU memory and cores due to excessively small datasets given the potential amount of parallelism that may be performed on the GPU.

In some embodiments, the sequence-based 2D variable length sample data 104 is received and processed by the 2D dynamic bucket pre-processor 110. Sequence-based 2D variable length sample data 104 may comprise, for example, tensor data that has two sequence lengths (e.g., an input sequence length and an output sequence length). As an example, for tensors representing audio data for use with training a speech-to-text model, the duration and content of an input utterance, and the number of tokens in the text prediction may represent two independent sequence length dimensions. Similar variability can occur with sequence-based 2D variable length sample data 104 that includes language data comprising sequences of words, characters, or tokens, or video data where data samples may comprise an arbitrary number of video frames depending on the length of a video segment. As shown in FIG. 1, the 2D dynamic bucket pre-processor 110 may include a memory for implementing 2D bucket buffers 120. As discussed in greater detail herein, the 2D bucket buffers 120 may operate as an arbitrary-input, arbitrary-output (AIAO) buffer wherein the order and/or timing of data input to the 2D bucket buffers 120 have no influence on the order and/or timing of data output from the 2D bucket buffers 120. The 2D dynamic bucket pre-processor 110 may further include one or more of a 2D sample data input manager 112, a bucket stratification optimizer 114, a batch size optimizer 116, and a training tensor batch manager 126.

In some embodiments, as the sequence-based 2D variable length sample data 104 is received by the 2D dynamic bucket pre-processor 110, it may be stored to the 2D bucket buffers 120 by the 2D sample data input manager 112. In some embodiments, the 2D bucket buffers 120 are instantiated to comprise a first tier comprising a plurality of stratified buckets (shown as first-tier buckets 122) that corresponds to the first tensor dimension (e.g., a sequence length dimension) of the sequence-based 2D variable length sample data 104. Each of the first-tier buckets 122 may then include a respective second tier of stratified buckets (or sub-buckets, shown as second-tier sub-buckets 124) that corresponds to the second tensor dimension (e.g., a sequence length dimension) of the sequence-based 2D variable length sample data 104. In some embodiments, when used for training a machine learning model, the first tensor dimension of sequence-based 2D variable length sample data 104 may have a sequence length that corresponds to a training sample used as the input to a machine learning model, while the second tensor dimension of the sequence-based 2D variable length sample data 104 may have a sequence length that corresponds to the output prediction produced from the machine learning model based on processing the first tensor dimension of sequence-based 2D variable length sample data 104. For a given tensor sample of the sequence-based 2D variable length sample data 104, the 2D sample data input manager 112 determines a first sequence length for that sample's first tensor dimension, and a second sequence length for that sample's second tensor dimension, and stores that sample to the bucket and sub-bucket combination of the 2D bucket buffers 120 that correspond to those first and second sequence lengths. For example, in the above example of first and second input samples of audio data, a first input sample of audio data of about five seconds of speech containing eight words may correspond to eight tokens for the model to predict (e.g., where individual tokens may correspond to a subword/segment of a word, and/or in some instances, a complete word). As such, the first tensor dimension corresponds to the five seconds of speech containing eight words (and having a first sequence length), while the second tensor dimension corresponds to the expected eight-token prediction of the model (the second sequence length). The second input sample of audio data of about five seconds of speech containing twelve words may correspond to sixteen tokens for the model to predict. Here, the first tensor dimension corresponds to the five seconds of speech containing twelve words (and having a first sequence length), while the second tensor dimension corresponds to the expected sixteen-token prediction of the model (the second sequence length). When processed by the 2D sample data input manager 112, the first and second input samples of audio data may be sorted into the same first-tier bucket 122 (e.g., a 3- to 8-second first-tier bucket) because they both have similar first tensor dimension sequence lengths of about five seconds. The 2D sample data input manager 112 may then select which second-tier bucket(s) 124 of that first-tier bucket 122 receive the first and second input samples based on their sequence lengths of their respective second tensor dimensions. For these examples, the 2D sample data input manager 112 may store the first input sample to a first sub-bucket 124 corresponding to 5 to 10 token sequence lengths, and store the second input sample to a second sub-bucket 124 corresponding to 15 to 20 token sequence lengths. As such, as the 2D variable length sample data 104 is received by the 2D dynamic bucket pre-processor 110, the 2D sample data input manager 112 iteratively populates the individual second-tier bucket 124 of each first-tier bucket 122 with samples that are closely similar with respect to both their first and second dimensions. When served to the model training platform 140, the training tensor batch 130 pulled from a selected second-tier bucket 124 may therefore be represented and processed by a GPU using a tensor that has first and second dimensions configured for that sub-bucket and thus needs little to no padding data to accommodate the full range of first and second dimensions of data samples pulled from that selected second-tier bucket 124.

In some embodiments, once the appropriate bucket and sub-bucket combination of the 2D bucket buffers 120 is selected for a sample of the 2D variable length sample data 104, the sample data input manager 112 may store that sample in an arbitrary buffer position of the sub-bucket 124. That is, as the input sequence of the 2D variable length sample data 104 is received, the sample data input manager 112 may be allocated into a slot of the assigned buffer at an arbitrary buffer position (e.g., selected randomly) within the sub-bucket 124 to improve the randomness of sampling when training tensor batch(es) 130 are served out by the training tensor batch manager 126 to the model training platform 140.

In some embodiments, the training tensor batch manager 126 may extract a micro-batch from a selected second-tier bucket 124 to serve to the model training platform 140 as a training tensor batch 130. For generating each training tensor batch 130 used by the model training platform 140 to perform a training step, the training tensor batch manager 126 may arbitrarily (e.g., randomly) select a different first-tier and second-tier combination, and produce a micro-batch of tensors processed from the corresponding sub-bucket 124.

The number of data samples to extract from a selected second-tier bucket 124 to form an individual training tensor batch 130 may be determined by the batch size optimizer 116 based on iteratively applying different batch sizes of optimization training data 117 to the model training platform 140 and evaluating resulting memory errors 118 generated by the model training platform 140.

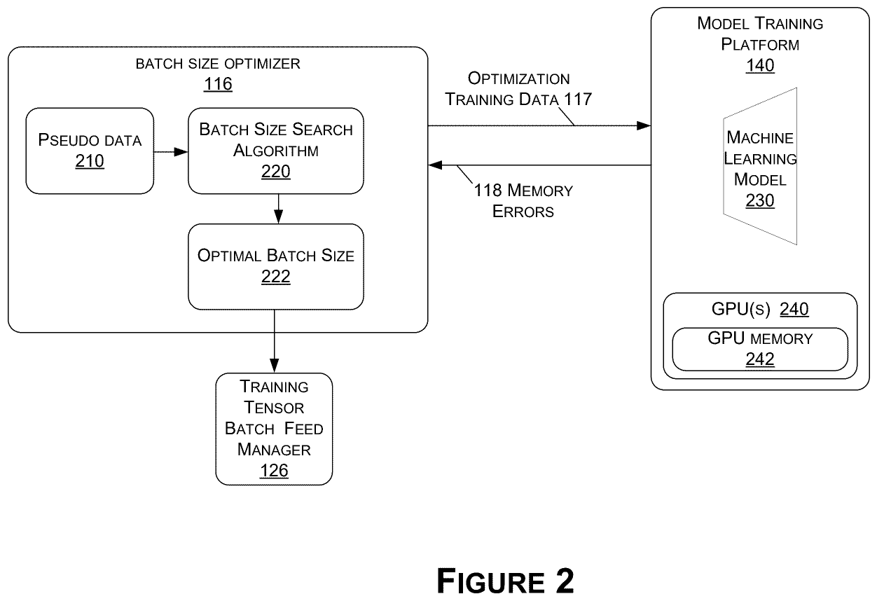

As now discussed and with reference to FIG. 2, a batch size optimizer 116 may comprise a batch size search algorithm 220 to compute an optimal batch size 222 that is used by the training tensor batch manager 126 to set the number of data samples extracted to form a training tensor batch 130 from a selected second-tier bucket 124. To determine the optimal batch size 222, the batch size search algorithm 220 conducts an iterative series of training steps on the model training platform 140 to converge on the optimal batch size 222. As shown in FIG. 2, the model training platform 140 may comprise one or more GPU(s) 240 with corresponding GPU memory 242, where the GPU(s) 240 execute training processes for training the machine learning model 230. For the purpose of batch size optimization, the batch size optimizer 116 performs one or more of the training processes for the purpose of determining an optimum mini-batch input size that the GPU(s) 240 can process without producing memory errors 118 due to exceeding one or more limitations of the GPU memory 242.

In some embodiments, the batch size search algorithm 220 is executed to identify a lower bound of GPU utilization, starting from an initial (e.g., seed) batch size setting. The batch size search algorithm 220 may optimize a lower bound of GPU utilization by selecting the largest possible batch sizes that fit into the GPU memory 242 of the GPU(s) 240. The batch size search algorithm 220 may compute an optimization based on running the machine learning model 230 on the GPU(s) 240 in a loop by feeding optimization training data 117 to the machine learning model 230. As discussed above, in some embodiments optimization training data 117 may comprise pseudo data 210. The batch size search algorithm 220 controls the batch size of optimization training data 117 being fed to the model training platform 140 and iteratively feeds different batch sizes while monitoring memory error 118 to identify a lower bound of GPU utilization automatically.

In some embodiments, batch size search algorithm 220 may initialize the optimization based on an initial batch size setting, and then adjust the batch size for a next iteration based on whether memory errors 118 were observed from the current iteration. The batch size search algorithm 220 may be implemented using, for example, a binary search variant. The optimization process may start with the initial batch size setting and run a full training step of the model, for example using a batch of optimization training data 117 comprising a set of pseudo data 210. Pseudo data 210 is an adequate substitute for real training data samples for the purpose of batch size optimization because the actual content of the data has no effect on the processing efficiency of GPU(s) 240 and is only relevant to the optimization process performed by the batch size search algorithm 220 with respect to sequence length. In some embodiments, the batch size search algorithm 220 performs a full training step of the machine learning model 230 (e.g., including forward propagation, backward propagation, and parameter updates) in order to obtain an accurate estimate of the actual GPU memory 242 utilization that would be incurred during a real training step. Starting with the initial batch size setting as an initial seed for a batch size, the batch size search algorithm 220 determines if a training step may be completed without the GPU(s) 240 running out of GPU memory 242. If that training step passes (e.g., can be performed without generating a memory error 118), then that batch size is marked as producing a successful training step. A next optimization iteration may then be performed using an increased batch size (e.g., two times the previous successful batch size). If instead a memory error 118 (e.g., an out-of-memory error) is generated, the batch size is marked as invalid and the batch size decreased (e.g., reduced by half) for the next iteration. In some embodiments, once the batch size search algorithm 220 has identified at least one successful batch size, and at least one invalid batch size, a middle point setting may be recursively tested to a convergence point (e.g., within a convergence threshold), which may be defined as the optimal batch size 222 for the GPU memory 242 configuration of the GPU(s) 240. In some embodiments, in order to bound the number of optimization iteration steps performed by the batch size search algorithm 220 to converge on an optimal batch size 222, the batch size search algorithm 220 may apply a convergence threshold, which is computed from a delta between valid and invalid batch sizes normalized by the larger number. For example, a 5% convergence threshold would mean that once the batch size search algorithm 220 finds a valid batch size (e.g., of 95) and an invalid batch size (e.g., of 100), the batch size optimizer 116 may stop the search process and define the batch size of 95 as the optimal batch size 222 provided to the training tensor batch manager 126. With this technique, the batch size optimizer 116 may be expected to converge on an optimal batch size 222 within about ten iteration steps per each bucket of the 2D bucket buffers 120 being optimized. That is, in some embodiments, the batch size optimizer 116 may compute an optimal batch size 222 for each tier 2 sub-bucket 124 from which data is extracted by the training tensor batch manager 126, and the training tensor batch manager 126 can use the corresponding optimal batch size 222 for the particular tier 2 sub-bucket 124 from which it is extracting data.

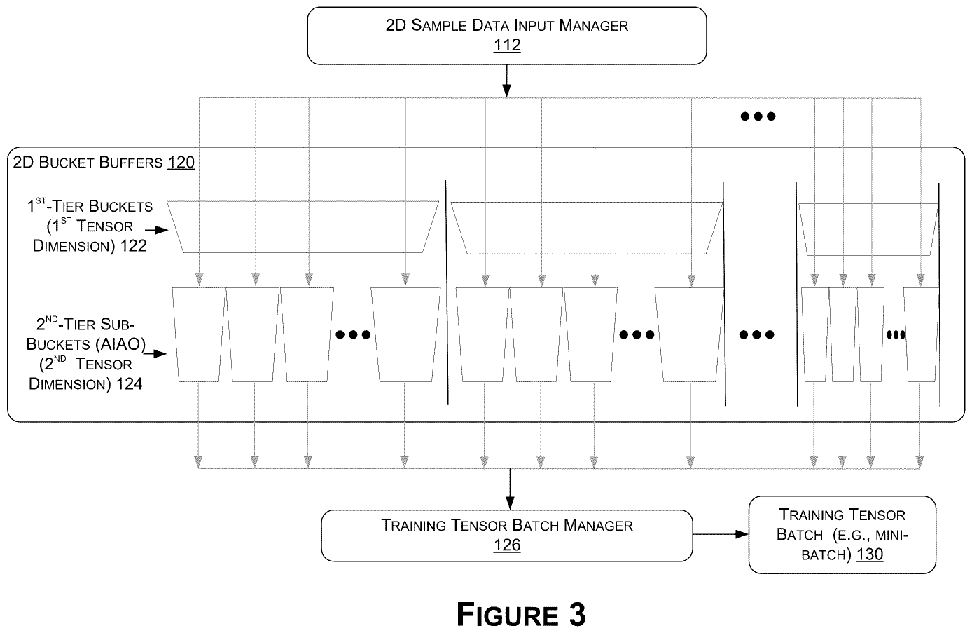

With respect to configuring a bucketing stratification for the 2D bucket buffers 120, the 2D dynamic bucket pre-processor 110 may further include the bucket stratification optimizer 114. The bucket stratification optimizer 114 may operate in conjunction with the batch size optimizer 116 to perform stratified two-dimensional (2D) bucketing sampling. As discussed above, a tensor used for model training may comprise a first sequence length dimension and a second sequence length dimension (e.g., which may correspond to an input sequence length dimension and an output sequence length dimension). The bucket stratification optimizer 114 described herein accounts for variability in the input and predicted output sequence length dimensions by configuring the 2D bucket buffers 120 for two-dimensional bucketing. For example, referring to FIG. 3, the 2D bucket buffers 120 are illustrated as instantiated to include the first tier of stratified buckets 122, where each of the first-tier buckets 122 may include a set of second-tier stratified buckets 124 (or sub-buckets 124). The stratifications of the first-tier buckets 122 and the second-tier buckets 124 are structured by the bucket stratification optimizer 114 such that each first-tier bucket 122 will be allocated a specified (not necessarily equal) quantity of sequenced data by the 2D sample data input manager 112. In some embodiments, the functions of the 2D sample data input manager 112 described herein may be integrated into the bucket stratification optimizer 114.

The bucket stratification optimizer 114 may estimate optimal 2D bucket sizes by computing one or more sequence length histograms on a sample (or entirety) of the 2D sample data 104. Furthermore, bucket bin boundaries may be determined by the bucket stratification optimizer 114 such that each first-tier bucket 122 (and/or sub-buckets 124 within a given bucket 122) will hold approximately an equal sum of sequence length. In some embodiments, the bucket stratification optimizer 114 may sort input data sequences, divide their sequence length sum by the desired number of first-tier buckets 122 (e.g., a selected hyperparameter), and iterate over the sorted examples, allocating them to buckets (and/or sub-buckets) sequentially until a maximum bucket sequence length sum is exhausted. Then, for each individual first-tier bucket 122, the bucket stratification optimizer 114 performs the same procedure, sub-dividing the bucket 122 into a fixed number of sub-buckets 124 (e.g., another selected hyperparameter) and iterates over the sorted sample of the bucket 122, allocating them to sub-buckets 124 sequentially until a maximum sub-bucket sequence length sum is exhausted. In some implementations, the bucket stratification optimizer 114 establishes bucket 122 and sub-bucket 124 boundaries in such a way that each sub-bucket 124 will hold roughly the same total amount in duration of data (e.g., seconds, hours, tokens, etc.). As such, though a set of sub-buckets 124 may each hold a similar total amount of data, a sub-bucket corresponding to smaller-sized 2D tensors may hold many more individual data samples than a sub-bucket corresponding to larger-sized 2D tensors.

In some embodiments, a sub-bucket 124 may be selected by the training tensor batch manager 126 to produce a training tensor batch 130 (e.g., a mini-batch) based on an interleaved and/or arbitrary selection scheme (e.g., randomly) rather than sequentially so that as training is performed by the model training platform 140, the progression through training steps avoids intervals of training with a constant sequence length. This optimization ensures that during training, each first-tier bucket 122 (and/or second-tier sub-bucket 124) will be processed in about the same amount of time rather than having buckets/sub-buckets of smaller-sized tensors exhausted quickly while others are exhausted late in the training process.

Because partitioning a very large dataset can take a substantial amount of time to complete (and consume a proportionally large amount of data storage), the 2D dynamic bucket pre-processor 110 may perform 2D bucketing to populate the 2D bucket buffers 120 as a dynamic process that streams data into the buckets and sub-buckets, while at the same time the training tensor batches 130 are being extracted from the 2D bucket buffers 120 and served by the training tensor batch manager 126 to the model training platform 140 to execute training steps. For example, the 2D sample data input manager 112 may add data to 2D bucket buffers 120 as the model training platform 140 consumes data from the 2D bucket buffers 120. In this way, the actual size of the buffer implementing the buckets may be bounded to a modest-sized buffer (e.g., without taxing the limits of the computing system hosting the 2D bucket buffers 120). In order to allocate an input data sample to a bucket on the fly, the 2D sample data input manager 112 may first measure a sample's 2D length to yield a vector of L1 (the first sequence length dimension), and L2 (the second sequence length dimension), and apply a binary search to match L1 to the corresponding first tier of buckets 122 (e.g., based on input sequence length), and apply a binary search to match L2 with the second tier of buckets 124 (e.g., sub-bucket) based on the second dimension (e.g., output sequence length). In order to reduce the lag between the start of filling the bucket and the start of the model training process, the 2D sample data input manager 112 may be executed to start performing the task of feeding the 2D bucket buffers 120, and the training tensor batch manager 126 may start serving the training tensor batch(es) 130 based on one or more buffer statistics 128. For example, the training tensor batch manager 126 may start serving the training tensor batch(es) 130 once it is at least a threshold percent populated (e.g., 10%), where the specific threshold may be tuned higher for large batch sizes relative to the 2D bucket buffers' 120 size.

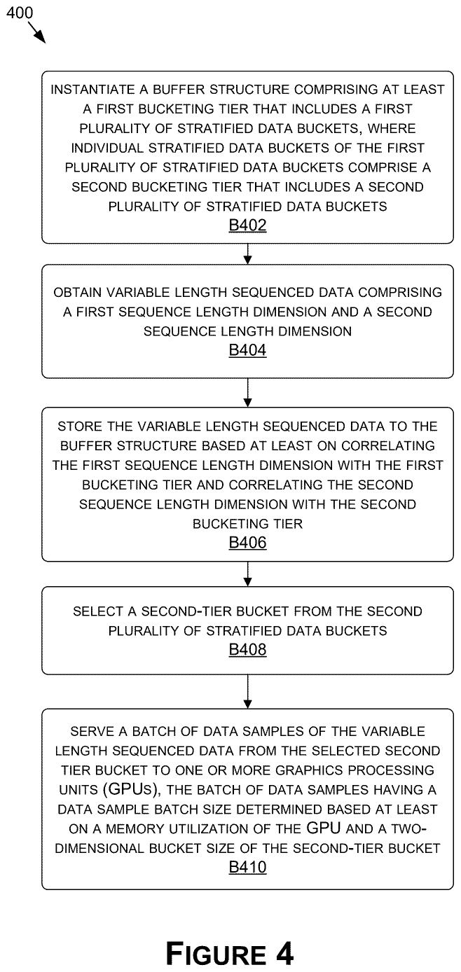

Now referring to FIG. 4, FIG. 4 is a flow diagram showing a method 400 for batch size-optimized 2D dynamic bucketing, in accordance with some embodiments of the present disclosure. It should be understood that the features and elements described herein with respect to the method 400 of FIG. 4 may be used in conjunction with, in combination with, or substituted for elements of any of the other embodiments discussed herein and vice versa. Further, it should be understood that the functions, structures, and other descriptions of elements for embodiments described in FIG. 4 may apply to like or similarly named or described elements across any of the figures and/or embodiments described herein and vice versa.

Each block of method 400, described herein, comprises a computing process that may be performed using any combination of hardware, firmware, and/or software. For instance, various functions may be carried out by one or more processors (e.g., one or more processing units comprising processing circuitry) executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 400 is described, by way of example, with respect to machine learning model training system 100 and/or the 2D dynamic bucket pre-processor 110 of FIG. 1. However, these methods may additionally or alternatively be executed by any one system, or any combination of systems, including, but not limited to, those described herein.

As discussed herein in greater detail, the method may in general include serving a batch of data samples of variable length sequenced data from a buffer structure to a graphics processing unit (GPU), the buffer structure comprising a first bucketing tier corresponding to a first sequence length dimension of the variable length sequenced data and a second bucketing tier corresponding to a second sequence length dimension of the variable length sequenced data, wherein the batch of data samples is served from a selected second-tier bucket of the buffer structure and comprises a data sample batch size determined based at least on a memory utilization of the GPU and a two-dimensional bucket size of the selected second-tier bucket.

The method 400, at block B402, includes instantiating a buffer structure comprising at least a first bucketing tier that includes a first plurality of stratified data buckets, where individual stratified data buckets of the first plurality of stratified data buckets comprise a second bucketing tier that includes a second plurality of stratified data buckets. As shown in FIG. 1, the 2D dynamic bucket pre-processor 110 may include a memory for implementing 2D bucket buffers 120. As discussed in greater detail herein, the 2D bucket buffers 120 may operate as an arbitrary-input, arbitrary-output (AIAO) buffer wherein the order and/or timing of data input to the 2D bucket buffers 120 have no influence on the order and/or timing of data output from the 2D bucket buffers 120. As the sequence-based 2D variable length sample data 104 is received by the 2D dynamic bucket pre-processor 110, it may be stored to the 2D bucket buffers 120 by the 2D sample data input manager 112. In some embodiments, the 2D bucket buffers 120 comprise a first tier comprising a plurality of stratified buckets (shown as first-tier buckets 122) that corresponds to the first tensor dimension (e.g., a sequence length dimension) of the sequence-based 2D variable length sample data 104. Each of the first-tier buckets 122 may then include a respective second tier of stratified buckets (or sub-buckets, shown as second-tier sub-buckets 124) that corresponds to the second tensor dimension (e.g., a sequence length dimension) of the sequence-based 2D variable length sample data 104. In some embodiments, when used for training a machine learning model, the first tensor dimension of sequence-based 2D variable length sample data 104 may have a sequence length that corresponds to a training sample used as the input to a machine learning model, while the second tensor dimension of the sequence-based 2D variable length sample data 104 may have a sequence length that corresponds to the output prediction produced from the machine learning model based on processing the first tensor dimension of sequence-based 2D variable length sample data 104. The method may, for example, determine bucket bin boundaries for at least one of the first bucketing tier and the second bucketing tier based on computing one or more sequence length histograms. In some embodiments, the buffer structure is instantiated by a pre-processor executed on a processing unit distinct from the one or more GPUs. The buffer structure may be instantiated by a pre-processor accessible as a network service hosted on a cloud-computing platform. In some embodiments, to instantiate the buffer structure, the method may measure a two-dimensional length of a data sample of the variable length sequenced data to obtain a first sequence length dimension vector and a second sequence length dimension vector; and apply a search algorithm to match the first sequence length dimension vector to a first corresponding bucket of the first bucketing tier and to match the second sequence length dimension vector to a second corresponding sub-bucket of the second bucketing tier.

The method 400, at block B404, includes obtaining variable length sequenced data comprising a first sequence length dimension and a second sequence length dimension. Sequence-based 2D variable length sample data 104 may comprise, for example, tensor data that has two sequence lengths (e.g., an input sequence length and an output sequence length). As an example, for tensors representing audio data for use with training a speech-to-text model, the duration and content of an input utterance, and the number of tokens in the text prediction, may represent two independent sequence length dimensions. Similar variability can occur with sequence-based 2D variable length sample data 104 that includes language data comprising sequences of words, characters, or tokens, or video data where data samples may comprise an arbitrary number of video frames depending on the length of a video segment. In some embodiments, when used for training a machine learning model, the first tensor dimension of sequence-based 2D variable length sample data 104 may have a sequence length that corresponds to a training sample used as the input to a machine learning model, while the second tensor dimension of the sequence-based 2D variable length sample data 104 may have a sequence length that corresponds to the output prediction produced from the machine learning model based on processing the first tensor dimension of sequence-based 2D variable length sample data 104.

The method 400, at block B406, includes storing the variable length sequenced data to the buffer structure based at least on correlating the first sequence length dimension with the first bucketing tier and correlating the second sequence length dimension with the second bucketing tier. As discussed herein, a 2D dynamic bucket pre-processor 110 may include one or more of a 2D sample data input manager 112, a bucket stratification optimizer 114, a batch size optimizer 116, and a training tensor batch manager 126. In some embodiments, as the sequence-based 2D variable length sample data 104 is received by the 2D dynamic bucket pre-processor 110, it may be stored to the 2D bucket buffers 120 by the 2D sample data input manager 112. For a given tensor sample of the sequence-based 2D variable length sample data 104, the 2D sample data input manager 112 determines a first sequence length for that sample's first tensor dimension, and a second sequence length for that sample's second tensor dimension, and stores that sample to the bucket and sub-bucket combination of the 2D bucket buffers 120 that correspond to those first and second sequence lengths. For example, in the above example of first and second input samples of audio data, a first input sample of audio data of about five seconds of speech containing eight words may correspond to eight tokens for the model to predict (e.g., where individual tokens may correspond to a subword/segment of a word, and/or in some instances, a complete word).

The method may store a data sample of the variable length sequenced data to an arbitrary (e.g., random) buffer position within the second-tier bucket when the variable length sequenced data is stored to the buffer structure.

The method 400, at block B408, includes selecting a second-tier bucket from the second plurality of stratified data buckets. In some embodiments, the training tensor batch manager 126 may extract a micro-batch from a selected second-tier bucket 124 to serve to the model training platform 140 as a training tensor batch 130. For generating each training tensor batch 130 used by the model training platform 140 to perform a training step, the training tensor batch manager 126 may arbitrarily (e.g., randomly) select a different first-tier and second-tier combination, and produce a micro-batch of tensors processed from the corresponding sub-bucket 124. The number of data samples to extract from a selected second-tier bucket 124 to form an individual training tensor batch 130 may be determined by the batch size optimizer 116 based on iteratively applying different batch sizes of optimization training data 117 to the model training platform 140 and evaluating resulting memory errors 118 generated by the model training platform 140.

The method 400, at block B410, includes serving a batch of data samples of the variable length sequenced data from the selected second-tier bucket to a graphics processing unit (GPU), the batch of data samples having a data sample batch size determined based at least on a memory utilization of the GPU and a two-dimensional bucket size of the second-tier bucket. The method may dynamically store the variable length sequenced data to the buffer structure while the batch of data samples is concurrently served to the one or more GPUs. For example, the 2D dynamic bucket pre-processor 110 may perform 2D bucketing to populate the 2D bucket buffers 120 as a dynamic process that streams data into the buckets and sub-buckets, while at the same time the training tensor batches 130 are being extracted from the 2D bucket buffers 120 and served by the training tensor batch manager 126 to the model training platform 140 to execute training steps. In some embodiments, the method may determine the data sample batch size based at least on iterative execution of a training step of a machine learning model on the GPU to converge on a valid batch size that does not generate a memory error. The number of data samples to extract from a selected second-tier bucket 124 to form an individual training tensor batch 130 may be determined by the batch size optimizer 116 based on iteratively applying different batch sizes of optimization training data 117 to the model training platform 140 and evaluating resulting memory errors 118 generated by the model training platform 140. The training step of the machine learning model may be executed on the one or more GPUs using pseudo data. Pseudo data 210 is an adequate substitute for real training data samples for the purpose of batch size optimization because the actual content of the data has no effect on the processing efficiency of GPU(s) 240 and is only relevant to the optimization process performed by the batch size search algorithm 220 with respect to sequence length. In some embodiments, the method may serve the batch of data samples from the selected second-tier bucket based on an interleaved selection scheme. The method may further execute a first training step of a machine learning model on the one or more GPUs based on the batch of data samples of the variable length sequenced data.

In some embodiments the method may select a second-tier bucket from the second plurality of stratified data buckets; and serve a second batch of data samples of the variable length sequenced data from the selected second-tier bucket to the one or more GPUs, the second batch of data samples having a second data sample batch size determined based at least on the memory utilization of the GPU and a two-dimensional bucket size of the second second-tier bucket.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). The simulation environment may use variable sequence length data to perform operations (e.g., navigating) associated with one or more virtual machines within the environment. These simulated operations may be used to test performance of the underlying algorithms, systems, and/or processes prior to deploying them in the real world. In some instances, the simulation may be used to generate synthetic training data—e.g., training data including regions of interest and/or subregions of interest from within the simulation. The synthetic training data (in addition to or alternatively from real-world data) may then be processed to determine geometry and/or other information related to road surfaces, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, and training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to produce processed image data related to animated or static objects, hazards, etc., which may be used or included in a visualization or mapping of an environment to aid a remote operator in controlling—or providing waypoints or other indications of control or navigation—an autonomous or semi-autonomous machine through an environment.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.), memory and/or storage (e.g., for storing control algorithms, sensor data, and one or more machine learning models), and memory and/or storage (e.g., for storing entertainment content, navigation data, and user preferences). The system may use these processors to execute one or more machine learning models to enable features such as occupant monitoring, gesture recognition, and real-time communication with other services through network connectivity. The in-vehicle infotainment system may also use natural language processing (NLP) models to enable voice-based interaction. The one or more machine learning models may be stored locally or accessed through one or more application programming interfaces (APIs) that connect to cloud services, enabling the system to process requests in real-time or near real-time.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers, etc.) to create a comprehensive model of the robot's surroundings. This data may be processed locally on the robot or sent to remote servers for more computationally intensive tasks, such as three-dimensional (3D) mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, vision language models (VLMs), large language models (LLMs), multimodal language models (MMLMs), diffusion models, neural rendering field (NeRF) models, deep neural networks (DNNs), etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

In some examples, the machine learning model(s) (e.g., deep neural networks, language models, LLMs, VLMs, multimodal language models, perception models, tracking models, fusion models, transformer models, diffusion models, encoder-only models, decoder-only models, encoder-decoder models, neural rendering field (NeRF) models, etc.) described herein may be packaged as one or more cloud-hosted microservices—such as one or more inference microservices (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as Representational State Transfer (REST) APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a preconfigured container for simplified deployment, an optimized inference engine (e.g., built using a standardized AI model deployment and execution software, such as NVIDIA's Triton Inference Server, and/or one or more APIs for high-performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device or up to data-center scale). As such, the inference microservice may include the machine learning model(s) (e.g., that has been optimized for high-performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more vision language models (VLMs) and/or one or more multi-modal language models (MMLMs), systems for performing light transport simulation, systems for performing collaborative content creation for 3D assets, systems implemented at least partially using cloud computing resources, and/or other types of systems.

### Example Computing Device

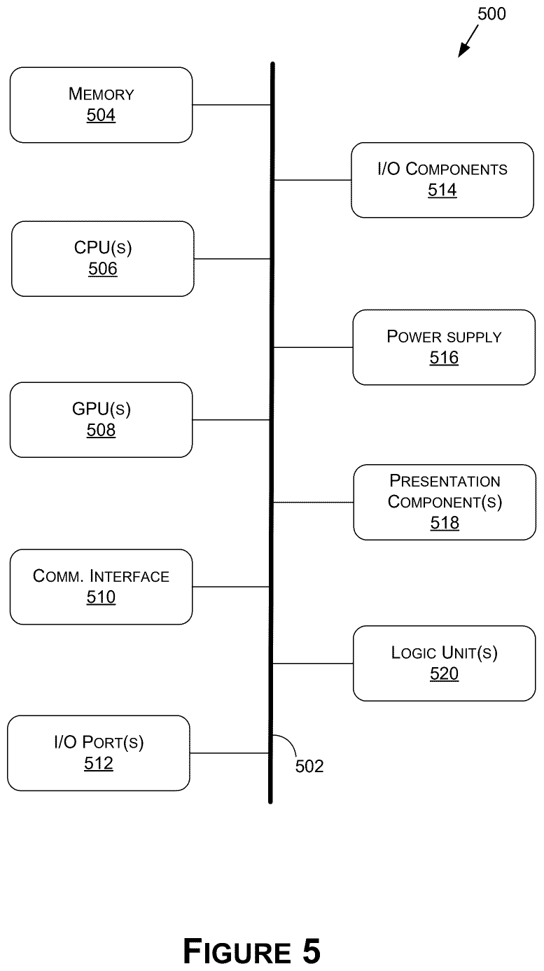

FIG. 5 is a block diagram of an example computing device(s) 500 suitable for use in implementing some embodiments of the present disclosure. In some embodiments, one or more aspects of the 2D dynamic bucket pre-processor 110 discussed herein may be performed by one or more elements of computing device(s) 500.

Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof. In some embodiments, one or more aspects of the 2D dynamic bucket pre-processor 110 discussed herein may be performed as code executed by one or more of the CPU(s) 506, GPU(s) 508 and/or Logic Unit(s) 520. In some embodiments one or more of the GPU(s) 240 of the model training platform may comprise one or more of the GPU(s) 508.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality content or virtual reality content.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

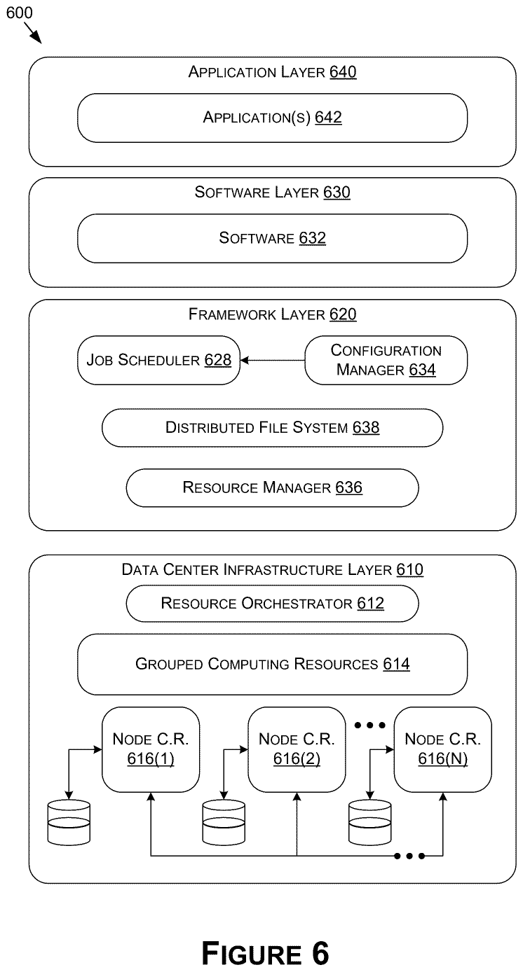

FIG. 6 illustrates an example data center 600 that may be used in at least one embodiments of the present disclosure. The data center 600 may include a data center infrastructure layer 610, a framework layer 620, a software layer 630, and/or an application layer 640. In some embodiments, one or more aspects of the 2D dynamic bucket pre-processor 110 discussed herein may be performed by functions hosted by data center 600. In some embodiments, one or more functions of the 2D dynamic bucket pre-processor 110 discussed herein may be accessible as network services hosted by data center 600.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination. In some embodiments, one or more functions of the 2D dynamic bucket pre-processor 110 discussed herein may be performed by one or more of the node C.R.s 616(1)-616(N).

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In some embodiments, one or more aspects of the 2D dynamic bucket pre-processor 110 discussed herein may be performed by executing functions implemented by applications(s) 642 and/or software 632.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. One or more processors comprising processing circuitry to:
instantiate a buffer structure comprising at least a first bucketing tier that includes a first plurality of stratified data buckets, where individual stratified data buckets of the first plurality of stratified data buckets comprise a second bucketing tier that includes a second plurality of stratified data buckets;
obtain variable length sequenced data comprising a first sequence length dimension and a second sequence length dimension;
store the variable length sequenced data to the buffer structure based at least on correlating the first sequence length dimension with the first bucketing tier and correlating the second sequence length dimension with the second bucketing tier;
select a second-tier bucket from the second plurality of stratified data buckets; and
serve a batch of data samples of the variable length sequenced data from the selected second-tier bucket to one or more graphics processing units (GPUs) via transmission over one or more communication links, the batch of data samples having a data sample batch size determined based at least on a memory utilization of the one or more GPUs and a two-dimensional bucket size of the second-tier bucket.

2. The one or more processors of claim 1, wherein the processing circuitry is further to determine the data sample batch size based at least on iterative execution of a training step of a machine learning model on the one or more GPUs to converge on a valid batch size that does not generate a memory error.

3. The one or more processors of claim 2, wherein the processing circuitry is further to execute the training step of the machine learning model on the one or more GPUs using pseudo data.

4. The one or more processors of claim 1, wherein the processing circuitry is further to store a data sample of the variable length sequenced data to an arbitrary buffer position within the second-tier bucket when the variable length sequenced data is stored to the buffer structure.

5. The one or more processors of claim 1, wherein the processing circuitry is further to serve the batch of data samples from the selected second-tier bucket based on an interleaved selection scheme.

6. The one or more processors of claim 1, wherein the processing circuitry is further to execute a first training step of a machine learning model on the one or more GPUs based on the batch of data samples of the variable length sequenced data.

7. The one or more processors of claim 1, wherein the processing circuitry is further to:
select a second second-tier bucket from the second plurality of stratified data buckets; and
serve a second batch of data samples of the variable length sequenced data from the selected second-tier bucket to the one or more GPUs via transmission over the one or more communication links, the second batch of data samples having a second data sample batch size determined based at least on the memory utilization of the one or more GPUs and a two-dimensional bucket size of the second second-tier bucket.

8. The one or more processors of claim 1, wherein the processing circuitry is further to:
determine bucket bin boundaries for at least one of the first bucketing tier and the second bucketing tier based on computing one or more sequence length histograms.

9. The one or more processors of claim 1, wherein the buffer structure is instantiated by a pre-processor executed on a processing unit distinct from the one or more GPUs.

10. The one or more processors of claim 1, wherein the buffer structure is instantiated by a pre-processor accessible as a network service hosted on a cloud-computing platform.

11. The one or more processors of claim 1, wherein the processing circuitry is further to:
dynamically store the variable length sequenced data to the buffer structure while the batch of data samples is concurrently served to the one or more GPUs.

12. The one or more processors of claim 1, wherein the processing circuitry is further to:
measure a two-dimensional length of a data sample of the variable length sequenced data to obtain a first sequence length dimension vector and a second sequence length dimension vector; and
apply a search algorithm to match the first sequence length dimension vector to a first corresponding bucket of the first bucketing tier and to match the second sequence length dimension vector to a second corresponding sub-bucket of the second bucketing tier.

13. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multimodal language models (MMLMs);
a system implemented using one or more cloud-hosted microservices;
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or a system implemented at least partially using cloud computing resources.

14. A system comprising one or more processors to:
store variable length sequenced data to a buffer structure based at least on correlating a first sequence length dimension with a first bucketing tier of the buffer structure that includes a first plurality of data buckets and correlating a second sequence length dimension with a second bucketing tier of the buffer structure that includes a second plurality of data buckets, where individual data buckets of the first plurality of data buckets comprise the second bucketing tier; and
serve a batch of data samples of the variable length sequenced data from a selected second-tier bucket of the buffer structure to one or more graphics processing units (GPUs) via transmission over one or more communication links, the batch of data samples having a data sample batch size determined based at least on a memory utilization of the one or more GPUs and a two-dimensional bucket size of the selected second-tier bucket.

15. The system of claim 14, wherein the one or more processors are further to determine the data sample batch size based at least on iterative execution of a training step of a machine learning model on the one or more GPUs to converge on a valid batch size that does not generate a memory error.

16. The system of claim 14, wherein the one or more processors are further to execute a first training step of a machine learning model on the one or more GPUs based on the batch of data samples of the variable length sequenced data.

17. The system of claim 14, wherein the one or more processors are further to determine bucket bin boundaries for at least one of the first bucketing tier and the second bucketing tier based on computing one or more sequence length histograms.

18. The system of claim 14, wherein the one or more processors are further to dynamically store the variable length sequenced data to the buffer structure while the batch of data samples is concurrently served to the one or more GPUs.

19. The system of claim 14, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multimodal language models (MMLMs);
a system implemented using one or more cloud-hosted microservices;
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
serving a batch of data samples of variable length sequenced data from a buffer structure to one or more graphics processing units (GPUs) via transmission over one or more communication links, the buffer structure comprising a first bucketing tier that includes a first plurality of data buckets corresponding to a first sequence length dimension of the variable length sequenced data and a second bucketing tier that includes a second plurality of data buckets corresponding to a second sequence length dimension of the variable length sequenced data, individual data buckets of the first plurality of data buckets comprising the second bucketing tier, wherein the batch of data samples is served from a selected second-tier bucket of the buffer structure and comprises a data sample batch size determined based at least on a memory utilization of the one or more GPUs and a two-dimensional bucket size of the selected second-tier bucket.
